(19) United States
(12) Patent Application Publication
(10) Pub. No.: US 2026/0349282 A1
(43) Pub. Date: Nov. 5, 2026

(54) SMART GLASSES AND INDICATING-FUNCTION HINGE THEREOF

(71) Applicant: Solos Technology (Shenzhen) Limited, Shenzhen (CN)

(72) Inventors: Kwun Lam Tai, Shenzhen (CN); Chiu Ming So, Shenzhen (CN); Wai Kuen Kenny Cheung, Shenzhen (CN); Kenneth Fan, Somerville, MA (US)

(21) Appl. No.: 19/714,687

(22) Filed: Jun. 22, 2026

Related U.S. Application Data
(63) Continuation of application No. PCT/CN2024/141260, filed on Dec. 22, 2024.

(30) Foreign Application Priority Data
Dec. 22, 2023 (CN) 202323510582.1

(51) Int. Cl. G02C 11/00; G02C 5/22

(52) U.S. Cl. CPC G02C 11/10; G02C 5/22

(57) ABSTRACT

The present disclosure provides smart glasses and an indicating-function hinge thereof. A circuit board (2) is disposed in a smart hinge housing (1) of the indicating-function hinge; a light source (3) is disposed on the circuit board (2); and a control module can collect a current operating state signal of the smart glasses, and control the light source (3) to emit light of a corresponding color or emit light in a preset light-emitting mode. An inner side surface (13) of the smart hinge housing (1) facing the human head is provided with a light-transmitting area (11), which allows light to be emitted outward. A wearer may intuitively determine a current operating state of the smart glasses by the color or change mode of light transmitted through the light-transmitting area (11).

### CROSS-REFERENCE TO RELATED APPLICATIONS

The present application is a Continuation Application of PCT Application No. PCT/CN2024/141260, filed on Dec. 22, 2024, which claims the priority of Chinese Utility Model Application No. 202323510582.1, filed on Dec. 22, 2023, the entire contents of which are hereby incorporated by reference.

### TECHNICAL FIELD

The present disclosure relates to the technical field of smart glasses, and in particular to smart glasses and an indicating-function hinge thereof.

### BACKGROUND

Smart glasses are wearable glasses equipped with independent operating systems similar to smartphones, and various functions can be realized by embedding different software and functional modules. Smart glasses can realize wireless network access through mobile communication networks. Users can complete functions such as adding schedules, navigating maps, interacting with friends, taking photos and videos, making video calls with friends, and playing music through voice control or motion operation.

Currently, users mainly interact with the smart glasses by operating keys or interfaces; the function of interacting directly from a visual perspective is not realized, and user experience needs to be improved.

### SUMMARY

The purpose of the present disclosure is to provide smart glasses and an indicating-function hinge thereof. A light-emitting diode is integrated into a light-transmitting hinge of the smart glasses, and a current state of the smart glasses is transmitted to a user by emitting different colors and light emission modes, thereby facilitating the user's cognition and understanding of behaviors of the smart glasses, and improving user experience.

The present disclosure is realized by an indicating-function hinge for smart glasses. The indicating-function hinge includes a smart hinge housing; a circuit board disposed in the smart hinge housing; a light source disposed on the circuit board; and a control module configured to be electrically connected to the light source. The control module is configured to collect a current operating state signal of the smart glasses, and to control the light source to emit light of a corresponding color or emit light in a preset light-emitting mode; an inner side surface of the smart hinge housing facing the human head is provided with a light-transmitting area, or an entire inner side surface is the light-transmitting area, to allow light emitted by the light source to radiate outwards; and the control module is disposed on the circuit board and electrically connected to the light source, or the control module is disposed in a temple of the smart glasses, and when the temple is connected to the indicating-function hinge, the control module is electrically connected to the light source.

In order to achieve the above purpose, the present disclosure further provides smart glasses which include a front frame, a temple, and the above indicating-function hinge. One end of the smart hinge housing of the indicating-function hinge is in plug connection with or hinged to the front frame, and an other end of the smart hinge housing is in plug connection with or hinged to the temple.

In order to achieve the above purpose, the present disclosure further provides other smart glasses which include a front frame; and a first smart hinge and a second smart hinge respectively connected to two sides of the front frame. The first smart hinge is the above indicating-function hinge, and a part or an entire smart hinge housing of the second smart hinge is a light-transmitting area; and the front frame is further provided with a light guide strip that is embedded in the front frame, light emitted by the light source in the first smart hinge is transmitted to the second smart hinge via the light guide strip, and then transmitted to the light-transmitting area of the second smart hinge via a light guide assembly.

Advantages of the present disclosure are as follows:

In the present disclosure, the indicating-function hinge is applied to smart glasses. The circuit board is disposed in the smart hinge housing of the indicating-function hinge, the light source is disposed on the circuit board, and the control module can collect current operating state signals of all functional modules and control the light source to emit light of a corresponding color or emit light in a preset light-emitting mode. The inner side surface of the smart hinge housing facing the human head is provided with a light-transmitting area, or the entire inner side surface serves as the light-transmitting area, thereby allowing light to radiate outwards. A wearer can intuitively determine the current operating state of the smart glasses through the color or change mode of light emitted from the light-transmitting area. It can be seen that a display function is added to the indicating-function hinge in the present disclosure, and the user may obtain the operating state of the smart glasses without complicated gestures or voice commands. This configuration simplifies operation of the smart glasses and allows the user to better understand and recognize the behaviors of the smart glasses, thereby improving the user experience.

### BRIEF DESCRIPTION OF DRAWINGS

FIG. 1 is a cross-sectional schematic view of an indicating-function hinge according to a first Embodiment of the present disclosure, in which a smart hinge housing thereof is formed entirely of a light-transmitting material.

FIG. 2 is a cross-sectional schematic view of an indicating-function hinge according to a second Embodiment of the present disclosure, in which a part of a smart hinge housing thereof is a light-transmitting area.

FIG. 3 is a cross-sectional schematic view of the indicating-function hinge according to the second Embodiment of the present disclosure, in which an inner side surface of the smart hinge housing thereof is a light-transmitting area.

FIG. 4 is a cross-sectional schematic view of the indicating-function hinge according to the second Embodiment of the present disclosure, in which the inner side surface of the smart hinge housing is a light-transmitting area, and a top surface, a bottom surface and an outer side surface are non-light-transmitting areas.

FIG. 5 is a cross-sectional schematic view of the indicating-function hinge according to the second Embodiment of the present disclosure, in which the inner side surface of the smart hinge housing is the light-transmitting area, and the top surface, the bottom surface and the outer side surface are covered with a non-light-transmitting material.

FIG. 6 is a schematic view of the non-light-transmitting areas of the indicating-function hinge shown in FIG. 5 covered with a reflective layer.

FIG. 7 is a cross-sectional schematic view of an indicating-function hinge provided with a light guide assembly according to a third Embodiment of the present disclosure.

FIG. 8 is a perspective structural schematic view of smart glasses according to a fifth Embodiment of the present disclosure.

FIG. 9 is a structural schematic view of the smart glasses before assembling the smart hinge housing according to the fifth Embodiment of the present disclosure.

FIG. 10 is an enlarged view of region A in FIG. 9.

FIG. 11 is a perspective structural schematic view of a front frame of the smart glasses according to the fifth Embodiment of the present disclosure.

### DESCRIPTION OF EMBODIMENTS

For better illustrating the objects, technical solutions and advantages of the present disclosure, detailed descriptions will be given for the embodiments provided by the present disclosure with reference to the accompanying drawings. Apparently, the described specific embodiments are only used to explain the present disclosure, not to limit the present disclosure.

In the description of the present disclosure, it should be noted that, the oriental or positional relationships indicated by the terms “center”, “top”, “bottom”, “left”, “right”, “vertical”, “horizontal”, “inner”, “outer” and the like are only intended to facilitate the description of the present disclosure and simplify the description based on oriental or positional relationships shown in the accompanying drawings, not to indicate or imply that the apparatus or element referred must have a specific orientation, is constructed and operated in a specific orientation, and therefore cannot be understood as a limitation of the present disclosure. The terms “first”, “second” and “third” are only used for descriptive purposes, and cannot be understood as indicating or implying relative importance or implicitly indicating the number of technical features indicated. In addition, unless otherwise specified and limited, the terms “mount”, “interconnect”, and “connect” should be understood in a broad sense. For example, “connect” may be fixedly, detachably, or integrally as one piece; “connect” also may be directly or indirectly through an intermediate member, “connect” further may be internal communication of two members. The specific meanings of the above-mentioned terms in the present disclosure can be specifically understood by persons of ordinary skill in the art.

A first Embodiment:

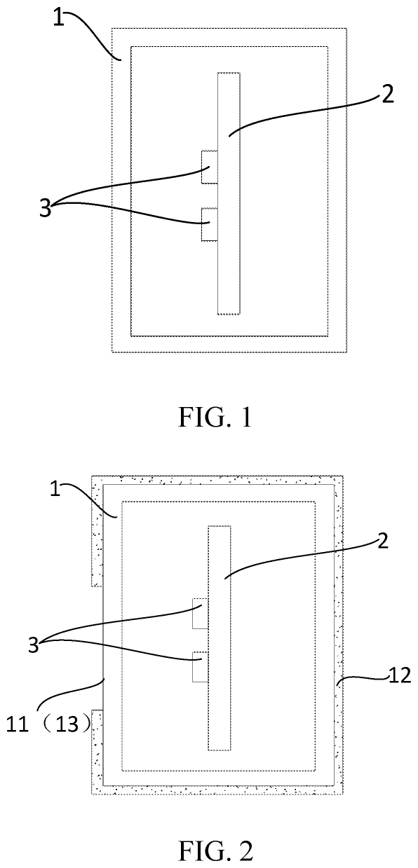

This embodiment provides an indicating-function hinge, which is configured for smart glasses. Referring to FIG. 1, the indicating-function hinge includes a smart hinge housing 1; a circuit board 2, a functional module and a control module disposed in the smart hinge housing 1; and a light source 3 disposed on the circuit board 2. The light source 3 is electrically connected to the functional module and the control module. The control module can collect a current operating state signal of the smart glasses through the functional module, and control the light source 3 to emit light of a corresponding color or emit light in a preset light-emitting mode. The entire smart hinge housing 1 is a light-transmitting area, thereby allowing light emitted by the light source 3 to radiate outwards.

The functional module and/or the control module may also be disposed in a temple of the smart glasses. After the temple is connected to the indicating-function hinge, the control module is electrically connected to the light source 3.

Specifically, an entire material of the smart hinge housing 1 is a transparent or light-transmitting material, so as to form the light-transmitting area. The light source 3 adopts an LED. A quantity of the LED may be one or more, and colors of a plurality of LEDs may be identical or different.

The present embodiment is described in detail below in conjunction with specific application examples:
1. State visualization: The LED is integrated into the light-transmitting smart hinge housing 1, so that the smart glasses can visually transmit its states to a user by emitting different colors and modes. Different colors and modes of the LED represent different operating states, such as active listening, waiting for a response or an idle state. This visual representation enhances the user's cognition and understanding of a behavior of the smart glasses.
2. User-friendly interaction: Interaction between the user and the smart glasses is simplified by LED indications in the light-transmitting smart hinge housing 1. In addition to an auditory cue or a graphical user interface, the user may also determine a current state of the smart glasses by glancing at the color or mode changes of the LED light in the light-transmitting smart hinge housing 1. The user may obtain the operating state of the smart glasses without using complicated gestures or voice commands, thereby making the smart glasses easier to use and the interaction between the user and the smart glasses more intuitive and quicker.
3. Clear and intuitive feedback: Clear and intuitive feedback may be provided for the user by the color and mode changes of the LED light, thereby ensuring smooth communication between the smart glasses and a wearer. For example, a green LED may indicate that the smart glasses are actively listening to the user's voice, while a red LED may indicate that the smart glasses are waiting for a response from the underlying “generative AI language model”. An extinguished LED indicates that the smart glasses stay in the idle state. This visual feedback allows the user to easily and clearly understand the current state of the smart glasses.
4. Error and notification signals: In addition to indicating the operating state of the smart glasses, the LED in the light-transmitting smart hinge housing 1 may also be configured to send error or notification signals to the user. For example, if an error occurs during a voice recognition or connection process, a specific color or mode may be displayed by the LED to alert the user. This function ensures that the user may be aware of important events or problems in a timely manner, thereby improving the overall user experience and reducing annoyances.
5. Design integration: The LED is skillfully embedded in the light-transmitting smart hinge housing 1, thereby providing a seamless and aesthetically pleasing design without affecting an appearance of the smart glasses. This design integration maintains the stylish and modern appearance of the smart glasses while adding valuable functions.

In summary, the indicating-function hinge of this embodiment is applied to the smart glasses; after the user wears the smart glasses, a position where the indicating-function hinge is disposed is not attached to the user's skin, and the wearer or people nearby can intuitively determine the current operating state of the smart glasses through the color or change mode of the light emitted from the light-transmitting area. It can be seen that, in this embodiment, a display function is added to the indicating-function hinge, and the user may obtain the operating state of the smart glasses without using complicated gestures or voice commands. This configuration makes the smart glasses easier to use and allows the user to better understand and recognize the behaviors of the smart glasses, thereby improving the user experience.

A second Embodiment:

The difference between this embodiment and the first Embodiment is as follows: a side of the smart hinge housing 1 facing the human head is an inner side surface 13. The inner side surface 13 facing the human head is provided with a light-transmitting area 11; a part of an outer surface of the smart hinge housing 1 is covered by spraying non-light-transmitting paint or a non-light-transmitting outer shell 12 (as shown in FIG. 2) mounted thereon to block light from escaping, and a portion of the inner side surface 13 of the smart hinge housing 1 corresponding to an uncovered part of the outer surface of the smart hinge housing 1 serves as the light-transmitting area 11 for light emission.

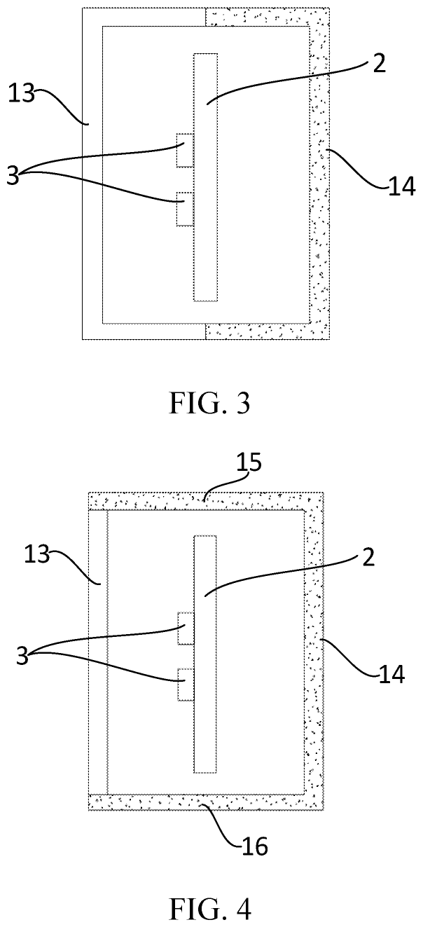

Specifically, referring to FIG. 3, a side of the smart hinge housing 1 facing away from the human head is an outer side surface 14, which adopts a non-light-transmitting material. The inner side surface 13 of the smart hinge housing 1 adopts the light-transmitting material to serve as the light-transmitting area. A light emission direction of the light source 3 is directed towards the inner side surface 13 of the smart hinge housing 1, and thus the light is emitted outward through the inner side surface 13.

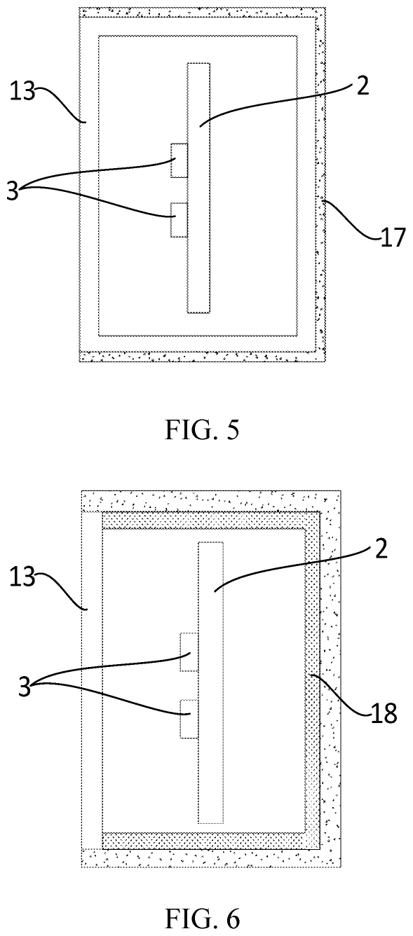

In other applications, as shown in FIG. 4, a top surface 15, a bottom surface 16 and the outer side surface 14 of the smart hinge housing 1 may all be set as non-light-transmitting areas. Alternatively, all other inner wall surfaces of the smart hinge housing 1 except the inner side surface 13 may be set as the non-light-transmitting areas (that is, the top surface 15, the bottom surface 16, the outer side surface 14, a front end surface and a rear end surface of the smart hinge housing 1 are all set as the non-light-transmitting areas). The non-light-transmitting areas are formed by using the non-light-transmitting material at corresponding positions of the smart hinge housing 1. It is easy to understand that the non-light-transmitting areas may also be formed by covering the corresponding positions of the smart hinge housing 1 with a non-light-transmitting material 17 (as shown in FIG. 5).

Further, referring to FIG. 6, the non-light-transmitting areas may be covered with a reflective layer 18. Light from a side thereof may be reflected to the light-transmitting area via the reflective layer 18, thereby improving light efficiency.

A third Embodiment:

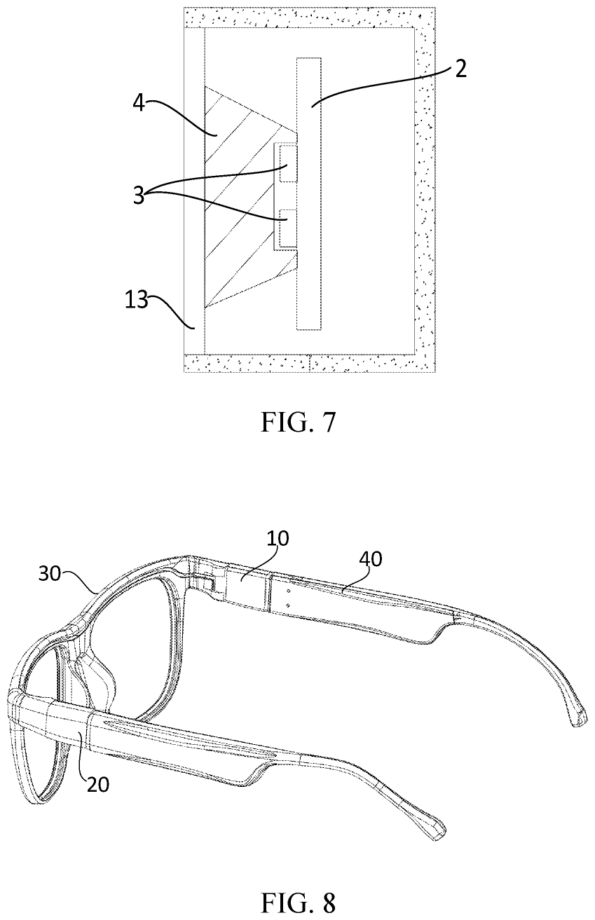

The difference between this embodiment and the second Embodiment is as follows: referring to FIG. 7, in this embodiment, the smart hinge housing 1 is further provided with a first light guide assembly 4 that is embedded in the smart hinge housing 1. The first light guide assembly 4 is configured to transmit the light emitted by the light source 3 to the light-transmitting area 11. The light may be converged and conducted along a specified direction through the first light guide assembly 4, which is conducive to improving light brightness.

### A Fourth Embodiment:

The difference between this embodiment and the second Embodiment is that the smart hinge housing 1 of this embodiment is further provided with a second light guide assembly that is embedded in the smart hinge housing 1. The second light guide assembly is configured to guide light to a front frame, thereby allowing the wearer to further view a light prompt from the front frame.

This embodiment further provides smart glasses, which include a front frame, a temple and the indicating-function hinge of this embodiment. One end of the smart hinge housing 1 of the indicating-function hinge is hinged to or in plug connection with the front frame, and an other end of the smart hinge housing 1 of the indicating-function hinge is hinged to or in plug connection with the temple.

The front frame is provided with a light-transmitting window. One end of the second light guide assembly is located adjacent to the light source 3, and an other end of the second light guide assembly is connected to the light-transmitting window of the front frame. The second light guide assembly is configured to transmit the light emitted by the light source 3 to the light-transmitting window of the front frame.

It should be noted that the specific structures of the first light guide assembly in the third Embodiment and the second light guide assembly in the fourth Embodiment are not limited, as long as the light emitted by the light source 3 can be guided to the light-transmitting area 11 or the light-transmitting window of the front frame. For example, each specific structure may be a specially designed light guide body made of non-light-transmitting material. The light guide body is provided with a hollow channel, and the light emitted by the light source 3 can be transmitted by total internal reflection in the hollow channel and guided to the light-transmitting area or the light-transmitting window of the front frame. At this time, one end of the first light guide assembly 4 is located adjacent to the light source 3, and the other end thereof is located adjacent to the light-transmitting area 11. Similarly, one end of the second light guide assembly is located adjacent to the light source 3, and the other end thereof is located adjacent to the front frame of the smart glasses. For another example, the specific structures may also be optical assemblies with light guiding functions such as reflectors, lenses, prisms, and the like, which guide a transmission direction of light through reflection or refraction.

A fifth Embodiment:

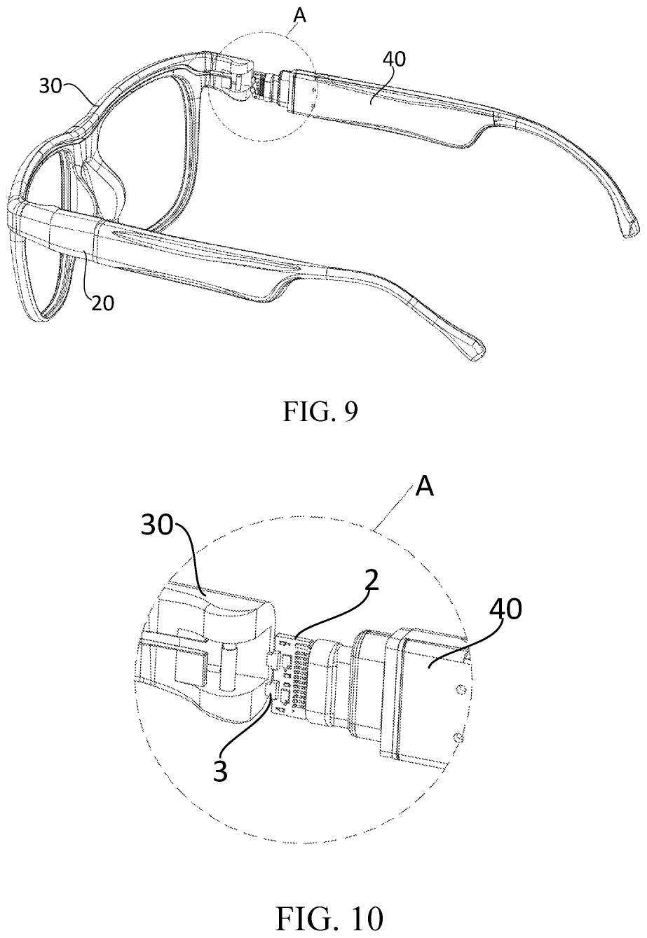

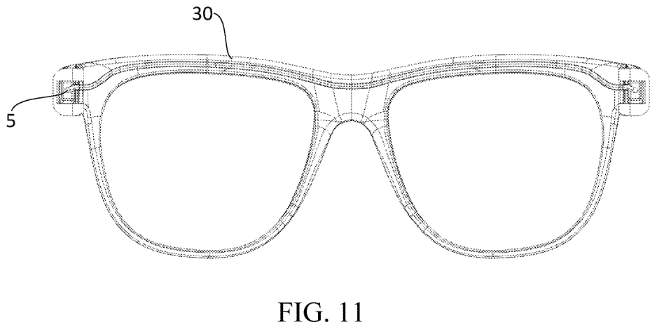

This embodiment provides smart glasses. Referring to FIGS. 8 to 11, the smart glasses include a front frame 30, a first smart hinge 10, a second smart hinge 20 and temples 40. Left and right ends of the front frame 30 are hinged to a first end of the first smart hinge 10 and a first end of the second smart hinge 20 respectively. A second end of the first smart hinge 10 and a second end of the second smart hinge 20 are in plug connection with one temple 40 respectively. In this embodiment, the first smart hinge 10 adopts the indicating-function hinge in the first Embodiment or the second Embodiment. An inner side surface of the smart hinge housing of the second smart hinge 20 facing the human head is provided with a light-transmitting area, or the entire inner side surface is a light-transmitting area. The front frame 30 is further provided with a light guide strip 5 that is embedded in the front frame 30. Light emitted by the light source 3 in the first smart hinge 10 is transmitted to the second smart hinge 20 via the light guide strip 5, and then transmitted to the light-transmitting area of the second smart hinge 20 via a light guide assembly.

Specifically, in this embodiment, the light guide strip 5 includes an optical fiber and a light-transmitting layer wrapped around the outer periphery of the optical fiber. The light guide strip 5 is embedded in a wire groove of the front frame 30, so that people opposite or next to the wearer can see the light. A position of a front side surface of the front frame 30 corresponding to the wire groove is a light-transmitting or transparent material.

The above merely describes preferred embodiments of the present disclosure without intention to limit the scope of the present invention. Any modifications, equivalent changes, improvements, and etc. made within the spirit and principle of the present disclosure should be within the scope of the present disclosure.

What is claimed is:

1. An indicating-function hinge for smart glasses, comprising:
a smart hinge housing;
a circuit board disposed in the smart hinge housing;
a light source disposed on the circuit board; and
a control module configured to be electrically connected to the light source,
wherein the control module is configured to collect a current operating state signal of the smart glasses, and to control the light source to emit light of a corresponding color or emit light in a preset light-emitting mode;
an inner side surface of the smart hinge housing facing the human head has a light-transmitting area, or an entire inner side surface is configured as the light-transmitting area, to allow light emitted by the light source to radiate outwards; and
the control module is disposed on the circuit board and electrically connected to the light source;
or the control module is disposed in a temple of the smart glasses, and when the temple is connected to the indicating-function hinge, the control module is electrically connected to the light source.

2. The indicating-function according to claim 1, wherein an entire material of the smart hinge housing is transparent or light-transmitting material.

3. The indicating-function hinge according to claim 1, wherein a part of an outer surface of the smart hinge housing is covered by spraying non-light-transmitting paint or a non-light-transmitting outer shell mounted thereon, and a portion of the inner side surface of the smart hinge housing corresponding to an uncovered part of the outer surface of the smart hinge housing serves as the light-transmitting area.

4. The indicating-function hinge according to claim 1, wherein a side of the smart hinge housing facing away from the human head is an outer side surface, a material of the outer side surface is a non-light-transmitting material; and a material of the inner side surface is a light-transmitting material, and a light emission direction of the light source is directed towards the inner side surface of the smart hinge housing.

5. The indicating-function hinge according to claim 4, wherein each of a top surface, a bottom surface and the outer side surface of the smart hinge housing is a non-light-transmitting area.

6. The indicating-function hinge according to claim 4, wherein all other inner wall surfaces of the smart hinge housing except the inner side surface are non-light-transmitting areas.

7. The indicating-function hinge according to claim 5, wherein the non-light-transmitting areas are formed by using the non-light-transmitting material at corresponding positions of the smart hinge housing, or are formed by covering the corresponding positions thereof with the non-light-transmitting material.

8. The indicating-function hinge according to claim 7, wherein the non-light-transmitting areas are covered with a reflective layer.

9. The indicating-function hinge according to claim 1, wherein the smart hinge housing is further provided with a first light guide assembly that is embedded in the smart hinge housing, and the first light guide assembly is configured to transmit the light emitted by the light source to the light-transmitting area.

10. The indicating-function hinge according to claim 1, wherein the smart hinge housing is further provided with a second light guide assembly that is embedded in the smart hinge housing, and the second light guide assembly is configured to guide the light emitted by the light source to a front frame of the smart glasses.

11. Smart glasses, comprising:
a front frame;
a temple; and
the indicating-function hinge according to claim 1,
wherein one end of the smart hinge housing of the indicating-function hinge is in plug connection with or hinged to the front frame, and an other end of the smart hinge housing is in plug connection with or hinged to the temple.

12. The smart glasses according to claim 11, wherein the smart hinge housing is further provided with a second light guide assembly that is embedded in the smart hinge housing, the front frame is provided with a light-transmitting window, one end of the second light guide assembly is located adjacent to the light source, an other end of the second light guide assembly is connected to the light-transmitting window, and the second light guide assembly is configured to transmit the light emitted by the light source to the light-transmitting window.

13. Smart glasses, comprising:
a front frame; and
a first smart hinge and a second smart hinge respectively connected to two sides of the front frame,
wherein the first smart hinge is the indicating-function hinge according to claim 1, and a part or an entire smart hinge housing of the second smart hinge is a light-transmitting area; and
the front frame is further provided with a light guide strip that is embedded in the front frame, light emitted by the light source in the first smart hinge is transmitted to the second smart hinge via the light guide strip, and then transmitted to the light-transmitting area of the second smart hinge via a light guide assembly.

14. The smart glasses according to claim 13, wherein the light guide strip comprises an optical fiber and a light-transmitting layer wrapped around outer periphery of the optical fiber.
